(19) United States
(12) Patent Application Publication
(10) Pub. No.: US 2026/0201719 A1
(43) Pub. Date: Jul. 16, 2026

(54) SYSTEM FOR CONSTRUCTING A SUSTAINABLE, RESILIENT BUILDING

(71) Applicant: Marshall Gobuty, Sarasota, FL (US)

(72) Inventor: Marshall Gobuty, Sarasota, FL (US)

(21) Appl. No.: 19/447,039

(22) Filed: Jan. 13, 2026

Related U.S. Application Data
(60) Provisional application No. 63/745,278, filed on Jan. 14, 2025.

(51) Int. Cl. E04H 9/14; E04B 1/64; E04B 1/74; E04H 9/02; H02J 3/32; H02J 9/06; H02S 20/25; H02J 101/24; H02J 105/12

(52) U.S. Cl. CPC E04H 9/145; E04B 1/644; E04B 1/74; E04H 9/021; H02J 3/32; H02J 9/062; H02S 20/25; H02J 2101/24; H02J 2105/12

(57) ABSTRACT

A system for constructing a sustainable and resilient building is disclosed. The system includes a monolithic foundation structure, reinforced wall structures, and a roof structure mechanically coupled by engineered structural connectors that provide a continuous load path from the roof to the foundation for resisting uplift and lateral forces associated with extreme wind events. The building includes sealed building envelope assemblies with impact-resistant fenestration and flood pressure relief elements configured to mitigate hydrostatic loads during flooding. An energy generation system supported by the roof, including a photovoltaic array with module-level power conversion devices, is electrically coupled to an energy storage system. A controller manages energy generation, storage, and distribution to critical building loads during utility grid outages. Non-penetrating roof attachments preserve roof integrity while supporting renewable energy components. The integrated structural, envelope, flood-mitigation, and energy systems collectively enhance durability, energy efficiency, and operational continuity under severe environmental conditions.

### TECHNICAL FIELD

The present disclosure generally relates to the field of building construction and building systems. More particularly, the disclosure pertains to the design and construction of sustainable and weather-resistant buildings that are configured to reduce environmental impact while improving structural resilience and energy reliability.

### BACKGROUND

The following description of related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

Conventional building construction techniques for residential and light commercial structures, including single-family homes, commonly rely on the extensive use of concrete and other materials associated with high energy consumption during manufacture. In many instances, such structures incorporate on the order of tens of tons of concrete per building. The manufacture of cement and concrete is energy-intensive and results in the emission of significant quantities of greenhouse gases, thereby contributing to a relatively high embodied carbon footprint for these structures. In addition, buildings constructed using traditional methods often exhibit elevated operational carbon emissions over their useful life due to inefficiencies in energy usage, heating, cooling, and power management. As a result, such buildings may be less compatible with emerging sustainability objectives and evolving regulatory, economic, and environmental considerations.

In parallel with environmental concerns, conventional buildings are increasingly exposed to adverse environmental conditions associated with climate variability, including more frequent and more severe storms, hurricanes, extreme precipitation events, and high-wind conditions. Many existing construction methods and building designs were developed based on historical weather patterns and may not adequately account for these changing conditions. Consequently, such buildings may be susceptible to structural damage, water intrusion, and degradation of building performance during extreme weather events, which can compromise occupant safety and habitability.

Another limitation associated with conventional buildings relates to electrical power reliability during adverse weather conditions. Electrical power outages commonly occur during storms and hurricanes due to damage to power generation facilities, transmission lines, and distribution infrastructure. To address short-term outages, some buildings are equipped with backup power systems, such as battery-based energy storage devices or portable generators. While such solutions may provide temporary power to selected loads, they are generally limited in capacity and duration, and may be insufficient to supply continuous power over extended outage periods. Additionally, existing backup solutions often operate independently of building structure and materials and may not be integrated with renewable energy sources, intelligent energy management systems, or load-balancing mechanisms, thereby limiting their ability to provide sustained, resilient power support during prolonged disruptions.

Accordingly, there exists a need for improved building systems and methods that address one or more of the foregoing limitations. In particular, there is a need for construction approaches that reduce the embodied carbon associated with building materials and construction processes, while also reducing operational carbon emissions during the life of the building. There is further a need for building systems that enhance resistance to extreme weather events and improve overall resilience.

Additionally, there is a need for integrated power solutions capable of supplying reliable and continuous electrical power during extended grid outages, including outages associated with severe weather, without relying solely on short-duration backup systems. Such improvements would preferably be achieved through coordinated integration of building structure, materials, energy generation, energy storage, and power management technologies.

### SUMMARY

Aspects of the present disclosure relate to building structures that incorporate an improved structural interface between a building slab or foundation and exterior wall structures, which enhances load transfer, durability, and resistance to environmental stresses such as high winds, flooding, and seismic or storm-related forces. In addition, the present disclosure relates to buildings that integrate on-site renewable energy generation and energy storage technologies. Specifically, the disclosure encompasses the incorporation of solar or photovoltaic (PV) panels in combination with one or more battery systems configured to store electrical energy and supply continuous or extended-duration power to the building. Such integration may enable improved power availability during utility grid interruptions, including those caused by severe weather events, while also reducing reliance on external energy sources during normal operation. The disclosed system is configured to resist uplift and lateral loads associated with extreme wind events, relieve hydrostatic pressure during flooding, and supply electrical power to critical loads during grid outages. Accordingly, the disclosure lies at the intersection of structural engineering, sustainable construction, and distributed energy systems, and is directed to building configurations and construction methods that jointly address structural performance, environmental sustainability, and electrical power resilience.

In one aspect, the present disclosure provides a system for forming a sustainable and resilient building. The system includes a foundation structure, a plurality of wall structures extending upward from the foundation structure, and a roof structure supported by the wall structures. The system further includes a plurality of structural connectors configured to provide a continuous mechanical load path from the roof structure, through the wall structures, and into the foundation structure. A plurality of building envelope assemblies are supported by the wall structures and the roof structure, and a plurality of fenestration elements are disposed in one or more of the building envelope assemblies. The system additionally includes a plurality of flood pressure relief elements positioned at one or more elevations in at least one of the wall structures and configured to relieve hydrostatic pressure during a flooding event. An energy generation system is supported by the roof structure, and an energy storage system is electrically coupled to the energy generation system and configured to provide electrical power to at least a subset of building loads during utility grid outages. The roof structure and the structural connectors cooperate with the wall structures and the foundation structure to resist uplift forces and lateral loads associated with extreme wind events, including hurricane-force winds.

In some embodiments, the foundation structure includes a monolithic concrete slab and an integral footing that are poured as a single, continuous unit. This monolithic construction eliminates cold joints between the slab and footing, improves structural continuity, and enhances resistance to uplift, settlement, and lateral forces. The integrated slab and footing configuration further improves load distribution from the wall structures into the supporting soil.

In some embodiments, each of the plurality of wall structures includes one or more concrete block walls formed from concrete masonry units. The concrete block walls include a plurality of fully grouted cells, each containing at least one vertical reinforcement bar extending between the foundation structure and one or more horizontal bond beams. This reinforced masonry configuration improves structural strength, stiffness, and resistance to vertical, lateral, and overturning loads.

In some embodiments, each of the fully grouted cells contains at least approximately 120 pounds of concrete surrounding the vertical reinforcement bar. The substantial volume of concrete within each cell increases the mass and compressive strength of the wall structures and enhances load transfer between the reinforcement bars, the bond beams, and the foundation structure.

In some embodiments, the roof structure includes a standing seam metal roof supported by the plurality of wall structures. The standing seam metal roof provides enhanced wind resistance, durability, and longevity, and includes raised seams that extend along the roof surface and serve as attachment points for rooftop equipment.

In some embodiments, each of the plurality of structural connectors includes a plurality of metal strapping elements distributed around a perimeter of the building. The metal strapping elements are configured to mechanically couple the roof structure, the wall structures, and the foundation structure, thereby establishing the continuous load path that transfers uplift and lateral forces from the roof structure into the foundation structure.

In some embodiments, each of the plurality of building envelope assemblies includes a plurality of framing members defining cavities that are fully filled with closed-cell spray foam insulation. The closed-cell spray foam insulation provides thermal insulation, air sealing, and moisture resistance, and adheres to the framing members to enhance structural rigidity.

In some embodiments, the closed-cell spray foam insulation disposed within the cavities of the framing members has a thickness of at least approximately six inches. This insulation thickness provides increased thermal resistance and contributes to improved energy efficiency and indoor environmental control.

In some embodiments, each of the building envelope assemblies includes a sheathing layer having taped seams that provide a sealed air and water barrier behind an exterior cladding. The taped sheathing layer reduces air infiltration and water intrusion and cooperates with the insulation to form a continuous building envelope.

In some embodiments, each of the fenestration elements includes one or more impact-resistant windows rated for severe wind events. The impact-resistant windows are configured to withstand wind-borne debris and pressure differentials associated with hurricanes and other extreme weather conditions.

In some embodiments, each of the flood pressure relief elements includes one or more hydro-sonic flood vents positioned at a height of approximately 14 inches above grade on at least one of the wall structures. The flood vents are configured to permit controlled bidirectional flow of water during flooding events, thereby equalizing hydrostatic pressure across the wall structures and reducing structural damage.

In some embodiments, the system includes a controller configured to coordinate electrical power flow among the energy generation system, the energy storage system, and one or more electrical loads during utility grid outages.

In some embodiments, the controller is configured to cause the energy storage system to discharge stored electrical power to at least a subset of the electrical loads during grid outages and to cause the energy storage system to recharge using electrical power generated by the energy generation system when such power is available.

In some embodiments, the energy generation system includes a photovoltaic array and a plurality of module-level power conversion devices configured to optimize the electrical output of individual photovoltaic modules of the photovoltaic array and to convert generated electrical power into a form suitable for use by the building.

In some embodiments, the energy storage system includes a battery pack configured to supply continuous electrical power to at least a subset of critical loads for an extended duration during grid outages, thereby maintaining essential building functions.

In some embodiments, the energy storage system and the energy generation system are configured such that the energy generation system generates at least as much electrical energy annually as is consumed by the building, resulting in net-zero or net-positive energy performance.

In some embodiments, the energy generation system is mechanically attached to the roof structure using a plurality of non-penetrating roof clamps that engage the standing seams of the metal roof without penetrating the roofing surface.

In some embodiments, the system includes a bidirectional utility meter configured to measure electrical energy delivered from, and exported to, an external electrical utility grid.

In some embodiments, the system further includes at least one electrical sub-panel configured to distribute electrical power from the energy storage system to a subset of the electrical loads during grid outages.

In some embodiments, the system includes a plurality of reinforcement sleeves disposed around at least one load-bearing structural element to increase the tensile strength and load-carrying capacity of the element.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

The diagrams are for illustration only, which thus is not a limitation of the present disclosure, and wherein:

FIG. 1 illustrates an exemplary schematic representation of a system to form a sustainable, weather-resistant and resilient building structure, in accordance with an embodiment of the disclosure.

FIG. 2 illustrates an exemplary representation of a roof structure of the building system, in accordance with an embodiment of the disclosure.

FIG. 3 illustrates an exemplary representation of a garage of the building system, in accordance with an embodiment of the disclosure.

FIGS. 4 and 5 illustrate exemplary representations of an energy generation system of the building system, in accordance with an embodiment of the disclosure.

FIG. 6 illustrates an exemplary representation of a controller operatively connected to the energy generation system and an energy storage system of the building system, in accordance with an embodiment of the disclosure.

The foregoing shall be more apparent from the following more detailed description of the invention.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that, various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”, “has”, “contains”, and other similar words are used in either the detailed description or the claims, such terms are intended to be inclusive, in a manner similar to the term “comprising” as an open transition word, without precluding any additional or other elements.

As used herein, “connect”, “configure”, “couple” and its cognate terms, such as “connects”, “connected”, “configured”, and “coupled” may include a physical connection (such as a wired/wireless connection), a logical connection (such as through logical gates of semiconducting device), other suitable connections, or a combination of such connections, as may be obvious to a skilled person.

As used herein, “send”, “transfer”, “transmit”, and their cognate terms like “sending”, “sent”, “transferring”, “transmitting”, “transferred”, “transmitted”, etc. include sending or transporting data or information from one unit or component to another unit or component, wherein the content may or may not be modified before or after sending, transferring, transmitting.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Embodiments of the present disclosure relate to a system for forming or constructing a sustainable, resilient building (hereinafter “building system” or “system”) configured to resist extreme environmental hazards such as high winds and floods, while also providing distributed energy generation and uninterrupted power during grid outages. The building systems is capable of withstanding hurricanes of category 4-5. In addition, such buildings are equipped to have an uninterrupted power supply, which is made possible by using an integrated in-house energy generation and storage solution. As may be appreciated, the buildings are single family homes and the terms building and home may be used interchangeably, herewith.

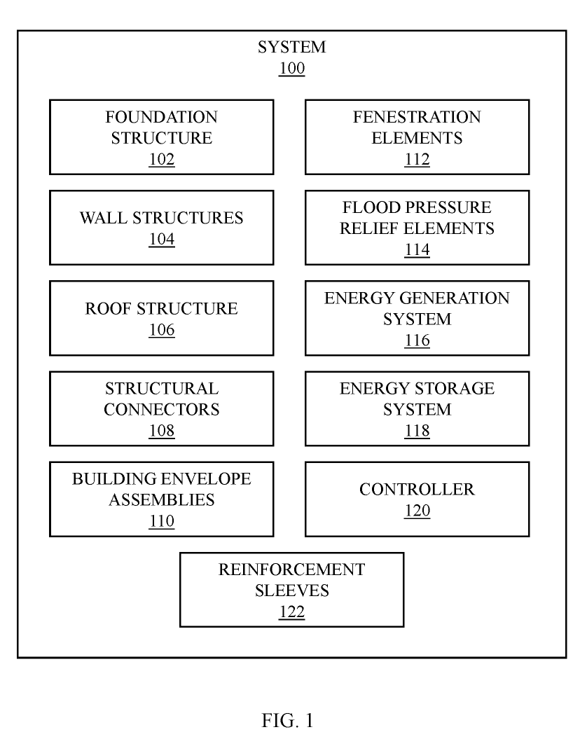

Referring generally to FIG. 1, the present disclosure relates to a system 100 (also referred to herein as a “building system” or “building”) for forming or constructing a sustainable and resilient building structure. The system 100 is configured to withstand extreme environmental events, including hurricane-force wind loads, wind-borne debris impacts, flooding events producing hydrostatic and hydrodynamic pressures, and prolonged utility grid outages, while simultaneously maintaining high energy efficiency, structural integrity, and operational continuity for occupants. In exemplary embodiments, the system 100 integrates multiple subsystems, including structural subsystems, building envelope subsystems, flood-mitigation subsystems, and energy generation and storage subsystems, into a unified and coordinated building design. These subsystems are not implemented as independent or isolated features, but instead are configured to cooperate mechanically and functionally so that loads, forces, and energy flows are transferred in a controlled and predictable manner throughout the building. Structurally, the system 100 is configured to provide a continuous mechanical load path extending from a roof structure, through intermediate structural components such as wall structures and connectors, and into a foundation structure. This continuous load path enables uplift forces, lateral wind loads, and overturning moments induced by extreme wind events to be transferred efficiently to the foundation and ultimately into the supporting soil. By contrast to conventional construction techniques that rely on intermittent or discontinuous anchoring, the integrated load path of the system 100 reduces stress concentrations and minimizes potential points of structural failure during high-load events.

From an energy and operational perspective, the system 100 further provides a continuous electrical energy pathway extending from an energy generation system supported by the roof structure, through power conversion and control components, and to end-use electrical loads within the building. Electrical energy generated at the roof level may be conditioned, stored, and selectively distributed to building loads, including critical loads, during normal operation and during grid outages. The coordination of structural and electrical systems allows the building to remain habitable and functional even when external utility services are disrupted. Materials used in the system 100 may include, by way of non-limiting example, reinforced concrete for foundation components, concrete masonry units with internal reinforcement for wall structures, engineered metal connectors for load transfer, high-performance insulation and sheathing materials for the building envelope, and photovoltaic modules and electrochemical batteries for energy generation and storage. The cooperative interaction of these materials and components enables the system 100 to achieve improved resilience, durability, and sustainability relative to conventional building systems, particularly in regions prone to severe storms, flooding, and infrastructure instability.

The system 100 includes a foundation structure 102 comprising a monolithic concrete slab and an integral footing poured as a single, continuous concrete placement. In exemplary embodiments, the slab has a thickness of approximately four inches, although other thicknesses may be used depending on design loads and soil conditions. The concrete forming the slab may include fiber reinforcement, such as synthetic or steel fibers, to improve crack resistance, impact resistance, and long-term durability. The integral footing extends downward below the slab to distribute vertical loads, lateral loads, and overturning moments from the superstructure into the supporting soil. A vapor barrier, such as a polymeric sheet including polyethylene or a similar moisture-resistant material, may be disposed beneath the slab. The vapor barrier may include lapped and sealed seams to inhibit moisture migration from the ground into the concrete and to improve curing conditions during placement. A plurality of vertical reinforcement bars, such as steel rebar, are embedded within the slab and footing and extend upward into the wall structures of the building system 100, thereby establishing a continuous mechanical load path between the foundation structure 102 and the overlying structural components. By pouring the slab and footing as a single integrated unit, cold joints are eliminated, and the foundation structure 102 functions as a unified load-bearing element configured to resist uplift forces, lateral loads, and overturning forces associated with extreme environmental events, including high winds and flooding.

In some embodiments, the foundation structure 102 includes at least one monolithic concrete slab reinforced with a combination of discrete fibers and steel reinforcement, selected based on anticipated structural loads and site-specific conditions. The monolithic concrete slab may have a thickness of approximately four inches and may incorporate fiber reinforcement to enhance crack control, toughness, and resistance to shrinkage-related cracking. The slab is poured over a continuous vapor retarder, such as a six-mil polyethylene sheet, which extends beneath the slab and footing and includes lapped and taped seams to minimize moisture transmission from the underlying soil into the concrete. The vapor retarder not only inhibits moisture migration into the monolithic concrete slab but also assists in maintaining uniform curing conditions during concrete hydration. Improved curing conditions contribute to increased compressive strength, reduced cracking, and improved long-term performance of the foundation structure 102. In combination with the integrated slab and footing geometry, the reinforced monolithic construction provides a stable and durable base for the building system 100, supporting the transfer of structural loads and enhancing resistance to environmental stresses over the operational life of the building.

The system 100 includes a plurality of wall structures 104 extending upward from the foundation structure 102. The wall structures 104 may include exterior load-bearing walls, interior structural walls, or combinations thereof. In one or more embodiments, at least a portion of the wall structures 104 comprises concrete masonry unit (CMU) walls. The CMU walls include a plurality of hollow cells, a substantial number of which are configured as fully grouted cells. Each fully grouted cell contains concrete and at least one vertical reinforcement bar extending between the foundation structure 102 and one or more horizontal bond beams formed within the wall structure. In exemplary embodiments, each fully grouted cell contains approximately 120 pounds of concrete, although greater or lesser quantities may be used depending on block dimensions and structural requirements. The concrete fill increases the mass, stiffness, compressive strength, and load resistance of the wall structures 104, improving performance under wind, impact, and flood-induced loads. The horizontal bond beams may be formed using knock-out masonry units and include horizontal reinforcement bars embedded in concrete. The vertical reinforcement bars may be mechanically tied to the horizontal reinforcement bars, thereby forming an integrated reinforcement network that improves moment continuity, load transfer efficiency, and resistance to lateral and uplift forces acting on the wall structures 104.

In some embodiments, a subset of the exterior wall structures 104 is constructed using CMUs having hollow cells that are substantially or fully filled with concrete. Each filled cell is configured to contain a minimum quantity of concrete on the order of approximately 120 pounds (lbs) per cell, although alternative quantities may be used depending on block geometry, reinforcement spacing, and design loads. Vertical reinforcing steel bars (rebar) extend through the filled cells and are mechanically tied into double knock-out horizontal bond beams formed at selected courses of the CMU walls. Lower ends of the vertical reinforcing bars extend into the monolithically poured slab and footing of the foundation structure 102, thereby establishing structural continuity between the foundation and the wall structures 104. This integrated reinforcement configuration improves load distribution, moment continuity, and resistance to uplift and lateral forces relative to conventional partially grouted masonry walls, which often rely on intermittent reinforcement and discontinuous load paths.

In some embodiments, one or more hydrostatic or hydrodynamic flood vents are installed within exterior wall structures 104 at a predetermined elevation. By way of example, the flood vents may be positioned at approximately fourteen inches above a reference surface, such as the slab surface or exterior grade level, although other elevations may be selected based on site-specific flood profiles, regulatory requirements, or anticipated water levels. The flood vents are configured to permit controlled bidirectional flow of water through the wall structures 104 during rising and receding flood conditions. By allowing water to enter and exit the enclosed space in a controlled manner, the flood vents equalize hydrostatic pressure on opposing sides of the wall structures 104. This pressure equalization significantly reduces lateral loads imposed on the wall structures during flooding events and correspondingly reduces the likelihood of structural failure, cracking, or wall blowout that can occur in buildings lacking engineered flood venting. Compared to conventional construction practices in which exterior walls are sealed against water ingress, the disclosed venting configuration provides improved flood resilience and structural survivability.

In some embodiments, the wall structures 104 are equipped with structural sheathing panels incorporating an integrated weather-resistant barrier on exterior wall framing. Seams between adjacent sheathing panels are sealed using compatible tapes, sealants, or membranes, thereby forming a continuous air and water control layer. An exterior cladding, such as fiber cement siding, is installed over the sheathing layer. The combination of taped sheathing and fiber cement cladding provides a redundant air and water barrier system, reducing the risk of water intrusion and uncontrolled air leakage relative to construction approaches that rely on a single-layer housewrap, such as spun-bonded polyolefin membranes, used in combination with conventional siding materials. The fiber cement cladding further contributes to improved fire resistance, impact resistance, resistance to wind-driven rain, and long-term durability. As a result, the exterior wall system is particularly well suited for use in storm-prone, flood-prone, and wildfire-prone regions.

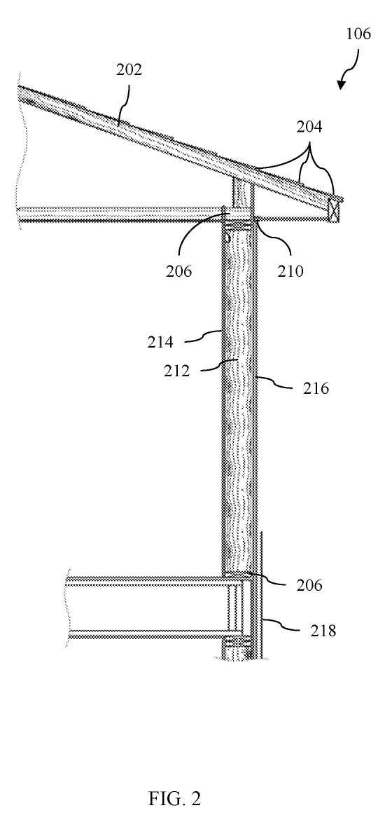

The system 100 further includes a roof structure 106, as illustrated in FIG. 2, which is supported by the wall structures 104. In one or more embodiments, the roof structure 106 includes a standing seam metal roof 202 installed over roof framing members and roof sheathing, such as plywood sheathing. The standing seam metal roof 202 may be installed in compliance with applicable Notice of Acceptance (NOA) requirements and product approval standards to ensure performance under extreme wind and weather conditions. The standing seam metal roof 202 includes a plurality of raised seams extending along an upper surface of the roof structure 106, which provide enhanced wind resistance and serve as attachment features for rooftop equipment. The roof structure 106 is configured to resist uplift forces generated by extreme wind events and to provide secure attachment points for rooftop equipment without penetrating the roofing surface. A plurality of photovoltaic (PV) modules or panels 204 may be installed over the standing seam metal roof 202. In particular, the standing seam configuration enables the PV panels 204 to be mechanically attached to the raised seams using clamps or clips, thereby eliminating the need for roof penetrations. This non-penetrating attachment reduces the risk of water intrusion and minimizes the likelihood of PV panel detachment or lifting during hurricane-force winds, which could otherwise pose safety hazards. In one or more embodiments, the roof structure 106 further includes Simpson Strong-Tie strapping mechanisms 206 and 208 used for structural reinforcement, in combination with a double top plate 210 that is secured using Simpson Stud-to-Plate (SP2) connectors at each stud-to-top-plate connection. The roof structure 106 may utilize a plurality of 2×6 studs 212, such as Spruce-Pine-Fir (SPF) or higher-grade lumber, which may be combined with spray foam insulation to provide enhanced thermal efficiency. An interior drywall 214 layer may be provided to form clean, finished interior surfaces, while ZIP panel wall sheathing 216 may be used to provide a continuous air and water barrier. The Simpson Strong-Tie strapping mechanisms 206 and 208 may be coupled at both upper and lower ends of each stud 212 to enhance structural integrity. An exterior Hardie board siding 218 may be installed over the ZIP panel wall sheathing 216 to provide durable, weather-resistant exterior protection.

The structural configuration of the building system 100 employs Simpson Strong-Tie mechanisms 206 and 208, or functionally equivalent engineered mechanical connectors, to mechanically couple the standing seam metal roof 202 to concrete block walls having fully grouted cells and to the monolithic slab foundation. These connectors are arranged to form a continuous, engineered structural load path extending from the roof framing, through the exterior wall structures 104, and into the foundation structure 102. This continuous load path improves resistance to uplift forces, lateral wind loads, and seismic forces. Simpson Strong-Tie mechanisms 206 and 208 represent a class of code-listed structural connectors designed to resist wind uplift and other environmental loads when properly selected and installed in accordance with manufacturer specifications and applicable building codes. In such embodiments, the standing seam metal roof 202 includes roof framing components such as rafters, trusses, or purlins, to which metal roof panels having continuous raised seams are attached. The connectors extend between designated members of the roof framing and top plates or other structural members of the exterior masonry walls. Fasteners suitable for each material type engage metal framing, masonry block, or embedded reinforcement as required. The exterior wall structures 104 include CMUs having a plurality of cells that are substantially or fully filled with concrete and contain vertical reinforcing bars. These reinforcing bars are mechanically tied into one or more horizontal bond beams and extend into the monolithic slab foundation. By mechanically coupling the roof assembly 106 to the reinforced masonry wall structures 104, the connectors transfer forces from the roof structure into the reinforced walls and through the reinforced masonry into the monolithic slab foundation. This configuration establishes a continuous structural load path configured to resist uplift and lateral loads resulting from extreme wind events.

In practice, specific types of Simpson Strong-Tie connectors 206 and 208 suitable for attaching timber or light-frame roof elements to masonry or concrete substrates may include masonry straps, truss anchors, embedded connectors, or tension ties designed for masonry applications. These connectors are selected and installed in accordance with structural engineering design criteria, including anticipated wind loads, uplift forces, and seismic demands for the project location. The connectors are typically fastened to the concrete or masonry using mechanical anchors, screws, or embedment components that engage the fully grouted CMU cells or the horizontal bond beam reinforcement. The connectors are fastened to the roof framing using nails, screws, or other suitable fasteners. A variety of Simpson Strong-Tie masonry connectors 206 and 208 are available for such applications, including masonry straps and embedded truss anchors that provide engineered mechanical connections between wood framing elements and masonry or concrete walls. By employing engineered mechanical connectors between the standing seam metal roof and the reinforced masonry walls, the building system 100 ensures that loads imparted on the roof by extreme weather, seismic activity, or other forces are effectively transferred through the exterior walls and into the monolithic slab foundation, thereby enhancing structural continuity, overall stability, and resilience compared to conventional connection methods.

The building system 100 may incorporate a variety of energy-efficient, durable, and sustainable construction features. For example, the roof structure 106 may utilize the standing seam metal roof design installed in accordance with NOA and product approval standards on robust plywood sheathing. The roof structure 106 is fully compatible with the PV panels 204, enabling seamless integration of renewable energy generation. The structural framing of the building may employ 2×6 SPF studs 212, which may be combined with spray foam insulation to deliver enhanced thermal performance and reduced energy consumption.

In some embodiments, the Simpson Strong-Tie strapping mechanisms 206 and 208 connect footers, foundation elements, slabs, and walls of the building system 100 to a sub-foundation. Additionally, a monolithic slab pouring process may be used in which the foundation structure 102 and the slab are poured simultaneously, allowing the concrete to cure as a single, unified mass for increased strength and durability. By way of example, more than forty steel straps forming the Simpson Strong-Tie strapping mechanisms 206 and 208 may be used in a single building to ensure adequate load transfer and redundancy.

The system 100 may incorporate daily-use battery systems that supply power to the building during night-time hours or utility grid outages. The batteries may recharge during daylight hours using energy generated by the PV panels 204, which may also power the building during daytime operation. In some embodiments, the PV panels 204 generate more energy than the building consumes on an annual basis, resulting in a net-zero or net-positive energy profile. Additionally, the system 100 may incorporate a Moen Flo water monitoring mechanism configured to monitor water pressure and flow within the building. The mechanism automatically shuts off the water supply when abnormal conditions are detected, thereby preventing leaks or pipe failures. The building may further include a Broan Fresh Air system incorporating air quality monitors configured to measure oxygen levels and detect smoke or other airborne contaminants, thereby promoting clean and healthy indoor air circulation.

In some embodiments, the system 100 provides 2×6 framing for both interior and exterior wall structures 104, rather than standard 2×4 framing. This framing configuration creates larger wall cavities capable of accommodating approximately six inches of spray foam insulation. The spray foam insulation enhances structural strength, improves energy efficiency, and increases building resilience. Walls, ceilings, and the roof structure 106 may be fully spray-foamed. Instead of conventional housewrap materials such as Tyvek®, the building may utilize ZIP panel sheathing, with taped seams to prevent water intrusion. For additional durability, James Hardie fiber cement board may be installed over the ZIP panels. In addition, double knock-out CMUs with fully filled cells and embedded reinforcing bars may be used to form solid reinforced concrete walls, with reinforcing bars extending between the monolithic slab and the CMU walls.

The exterior wall structures 104 may be framed using 2×6 structural members, providing wall cavities approximately six inches deep. These cavities are substantially or completely filled with spray-applied foam insulation, resulting in higher effective thermal resistance (R-value) compared to conventional 2×4 walls insulated with fiberglass batts. Closed-cell spray foam insulation may exhibit thermal resistance values on the order of R-6 to R-7 per inch, resulting in high whole-wall R-values. In addition to thermal performance, the full-depth spray foam insulation enhances structural performance. The cured foam adheres to framing members and sheathing, increasing composite action and resistance to racking and shear forces. The foam also provides enhanced air sealing by conforming to irregular cavity geometry and sealing penetrations, thereby reducing convective air infiltration and energy losses.

The disclosed wall structures 104 reduce operational energy consumption by minimizing heat transfer and improve resistance to lateral loads associated with high wind events. In some embodiments, approximately six inches of spray foam insulation is applied to the underside of the roof deck and within ceiling and wall structures, forming a substantially continuous thermal and air barrier from the foundation to the roof structure 106. This configuration reduces reliance on vented attic spaces and limits air leakage pathways, improving energy efficiency and resistance to wind-driven rain and moisture intrusion.

The structural framing further benefits from mechanical interaction between the spray foam insulation and the wood studs. The cured foam adheres to interior surfaces of the framing and sheathing, increasing composite action and improving resistance to racking and lateral loads. This interaction enhances wall stiffness and performance under wind and seismic loading.

In the roof assembly 106, framing members and cavity spaces are configured to receive a minimum thickness of approximately six inches of spray foam insulation extending from the top plate to the roof deck. The roof and ceiling assemblies may be foamed in place to form a semi-monolithic thermal and air barrier. In one representative embodiment, a wall structure stack-up includes, from interior to exterior:

(i) interior gypsum drywall;

(ii) a 2×6 stud cavity fully filled with closed-cell spray foam insulation;

(iii) structural sheathing panels incorporating an integrated weather-resistant barrier with taped seams; and

(iv) exterior cladding such as fiber cement board.

This multi-layer wall assembly 104 provides continuous insulation, air and water control, and a durable exterior surface, thereby contributing to the overall energy efficiency, durability, and resilience of the building system 100.

The system 100 also includes a plurality of structural connectors 108 distributed around a perimeter of the building and at selected structural interfaces between major load-bearing components. Each structural connector 108 may include, by way of example and without limitation, metal strapping elements, hold-down devices, tension ties, anchor straps, or other engineered mechanical connectors formed from galvanized steel or other corrosion-resistant metals. The structural connectors 108 mechanically couple the roof structure 106, the wall structures 104, and the foundation structure 102, thereby establishing a continuous and engineered structural load path extending from the roof to the foundation. In operation, uplift and lateral forces acting on the roof structure 106, such as those generated by hurricane-force winds or seismic activity, are transferred through the wall structures 104 and into the foundation structure 102 via the structural connectors 108, without reliance on friction-based connections or discontinuous fastening methods. This continuous load path configuration significantly improves resistance to extreme wind loads relative to conventional construction practices that rely on isolated anchorage points, toe-nailed joints, or gravity-based load transfer. The structural connectors 108 may include any combination of metallic straps, ties, and hold-downs installed throughout the structural frame to create continuity of load transfer from the roof structure 106 to the foundation structure 102. For example, in one embodiment, the structural connectors 108 may include at least forty metal straps per building, each mechanically connecting roof framing members, intermediate wall plates and studs, horizontal bond beams, and the slab foundation. The structural connectors 108 are configured to resist lateral forces, uplift forces, and overturning moments resulting from wind, seismic, and other environmental loads. Such structural connectors 108, including hurricane ties, hold-downs, and tension straps, are recognized as engineered and code-listed components for use in high-wind construction to provide continuity of load transfer and enhanced structural reliability.

The system 100 further includes a plurality of building envelope assemblies 110 supported by the wall structures 104 and the roof structure 106. Each building envelope assembly 110 may include interior finish materials, structural framing members, insulation, sheathing layers, and exterior cladding, arranged to collectively provide thermal control, moisture management, and structural support. In some embodiments, the framing members include nominal 2×6 studs defining wall cavities having a depth of approximately six inches. The cavities are substantially or fully filled with closed-cell spray foam insulation having a thickness of at least approximately six inches. The insulation provides high thermal resistance, effective air sealing, and moisture control. The closed-cell foam adheres to the framing members and adjacent surfaces, thereby increasing wall stiffness and contributing to resistance against racking and shear forces. A sheathing layer having integrated air- and water-barrier properties is installed outward of the framing members. Seams between adjacent sheathing panels are taped or otherwise sealed to form a continuous air and water barrier. An exterior cladding, such as fiber cement board, engineered wood siding, or an equivalent durable cladding material, is installed over the sheathing layer to protect the building envelope from environmental exposure.

In certain embodiments, the building envelope assemblies 110 are configured to provide enhanced thermal performance, structural stiffness, and resilience against environmental stressors. Exterior load-bearing and non-load-bearing walls of the building envelope assemblies 110 may be framed using nominal 2×6 wood studs, yielding wall cavities with a depth of approximately six inches. These cavities are substantially or fully filled with closed-cell spray-applied foam insulation. The closed-cell foam insulation forms a substantially continuous insulation layer and air barrier that provides higher effective thermal resistance than conventional insulation materials such as fiberglass batt insulation. In addition to thermal performance benefits, the spray foam insulation adheres to adjacent framing members and the sheathing layer, increasing composite action within the wall assembly and improving resistance to lateral racking forces induced by wind or seismic loads.

The system 100 also includes a plurality of fenestration elements 112 disposed within one or more building envelope assemblies 110. Each fenestration element 112 may include one or more impact-resistant windows rated for severe wind events, such as hurricane-force winds and wind-borne debris impacts. The impact-resistant windows may include laminated glass assemblies, reinforced frames, and anchoring systems designed to maintain structural integrity under high pressure differentials. The fenestration elements 112 are integrated into the continuous air and water barrier formed by the sheathing layer, flashing systems, and sealing materials, thereby maintaining building envelope continuity while permitting natural light transmission, outdoor visibility, and, in some cases, controlled ventilation. Proper integration of the fenestration elements 112 minimizes air leakage and water intrusion around window openings during extreme weather conditions.

In some embodiments, the fenestration elements 112 equip the building with impact-resistant hurricane-rated windows, such as Progressive Glass Technology (PGT) vinyl windows, which provide enhanced protection during hurricane events. In addition, wall structures 104 located at first-floor of the building 100 may include a plurality of hydro-sonic flood vents positioned approximately fourteen inches above ground level. These vents allow water to flow through the wall structures during flooding events, thereby reducing hydrostatic pressure on the walls and preventing structural damage. Further, a DuraDeck heat-sealed waterproofing system may be used to ensure that balconies and lanais are fully waterproofed.

The system 100 further includes a plurality of flood pressure relief elements 114 positioned within at least one wall structure 104. Each flood pressure relief element 114 may include one or more hydro-sonic flood vents installed at a predetermined elevation, such as approximately fourteen inches above grade, although other elevations may be selected based on site conditions or regulatory requirements. The flood vents are configured to permit bidirectional water flow during flooding events, allowing water to enter and exit enclosed spaces in a controlled manner as flood levels rise and recede. This controlled water flow equalizes hydrostatic pressure across the wall structures 104, thereby reducing lateral forces that could otherwise cause cracking, displacement, or structural failure of the wall assemblies. By relieving flood-induced pressure differentials, the flood pressure relief elements 114 improve the survivability and resilience of the building system 100 during flood events.

In some embodiments, the flood pressure relief elements 114 may include one or more water pressure sensors, flow sensors, or leak detection devices operatively coupled to an automatic shut-off valve configured to interrupt water supply in response to detected anomalies. Such anomalies may include, by way of example, leaks, burst pipes, abnormal flow rates, or abnormal pressure conditions. Upon detection of such conditions, the automatic shut-off valve is actuated to limit or prevent water damage within the building. In addition, the flood pressure relief elements 114 may include indoor air quality monitoring components configured to detect environmental conditions such as smoke, particulate matter, carbon dioxide levels, oxygen concentration, volatile organic compounds, or other airborne contaminants. By integrating water-related monitoring and air-quality monitoring within a unified system, the disclosed system 100 enables coordinated detection, alerting, and automated response actions. In contrast, typical residential buildings implement such protections, if at all, using discrete and uncoordinated devices that operate independently and lack system-level awareness. The integrated monitoring and protection solution enhances occupant safety, reduces property damage, and improves overall building resilience by providing automated, real-time responses to both water-related and air-quality-related hazards.

The system 100 includes an energy generation system 116 supported by the roof structure 106. In one or more embodiments, the energy generation system 116 includes a photovoltaic (PV) array comprising a plurality of PV modules 204. The PV modules are mechanically attached to the standing seam metal roof 202 using non-penetrating roof clamps that engage the raised seams of the standing seam metal roof 202 without penetrating the roofing surface. This non-penetrating attachment method preserves the integrity of the roof covering, reduces the risk of water intrusion, and maintains compliance with roofing warranties and wind-resistance certifications. The raised seams of the standing seam metal roof 202 provide structurally reinforced attachment points that enable secure clamping of the PV modules, thereby improving resistance to uplift forces during high-wind events. The energy generation system 116 further includes a plurality of module-level power conversion devices, such as micro-inverters or direct current (DC)-to-DC power optimizers, electrically coupled to individual PV modules 204. These module-level devices optimize energy output at the individual module level, compensate for shading or module mismatch, and convert DC electrical power generated by the PV modules into alternating current (AC) power suitable for use by the building’s electrical infrastructure.

The system 100 further includes an energy storage system 118 electrically coupled to the energy generation system 116. The energy storage system 118 includes at least one battery pack configured to store electrical energy generated by the PV array for later use. The battery pack may include one or more electrochemical battery technologies, such as lithium-ion, lithium iron phosphate, or other rechargeable battery chemistries selected for cycle life, safety, and energy density. A bidirectional utility meter is electrically coupled to the building electrical system and configured to measure electrical energy delivered from, and exported to, an external electrical utility grid. The bidirectional utility meter enables net metering or similar utility interconnection arrangements. One or more electrical sub-panels are provided to distribute electrical power from the energy storage system 118 to selected electrical loads during grid outages. In certain embodiments, the energy generation system 116 and the energy storage system 118 are sized and configured such that the building generates at least as much electrical energy annually as is consumed by the building, thereby achieving net-zero or net-positive energy performance.

The building system 100 includes an integrated energy management and power continuity system configured to coordinate renewable energy generation, energy storage, and load distribution. In one or more embodiments, a central controller 120 is configured to interface with the PV array, including PV modules or panels 204 installed over the roof assembly 106, individual module micro-inverters, the battery-based energy storage system 118, the bidirectional utility meter, and a critical loads sub-panel. The controller 120 is configured to coordinate electrical power flow among the energy generation system 116, the energy storage system 118, and one or more electrical loads. During normal grid-connected operation, the controller 120 manages power flows to optimize self-consumption of generated energy and export excess energy to the utility grid when appropriate. During grid outages, the controller 120 automatically isolates the building from the utility grid and causes the energy storage system 118 to discharge stored electrical power to at least a subset of critical loads. When electrical energy generated by the PV array is available, the controller 120 causes the energy storage system 118 to recharge while simultaneously supplying power to building loads as appropriate. In some embodiments, the controller 120 manages energy flows such that predefined critical circuits, including refrigeration, communications equipment, lighting, medical devices, and essential Heating Ventilation and Air-Conditioning (HVAC) components, remain powered for a predetermined duration during grid outages, such as several hours or longer, depending on battery capacity and load demand. The building system 100 may further include a unified building automation interface configured to integrate multiple environmental and safety monitoring systems. In certain embodiments, this interface receives signals from a water pressure monitoring and automatic shut-off device configured to control the main water supply in response to detected leaks or abnormal pressure conditions. The interface also receives data from indoor air quality monitoring devices configured to detect smoke, elevated particulate matter, low oxygen levels, carbon dioxide concentration, or other airborne contaminants. Integration of these monitoring subsystems with battery status indicators and energy system performance data provides a coordinated monitoring and control platform that enhances occupant safety, resource management, and property protection.

In some embodiments, the system 100 further includes a plurality of reinforcement sleeves 122 disposed around selected load-bearing structural elements. The reinforcement sleeves 122 may be formed from high-strength composite materials and are configured to increase the tensile strength and load-carrying capacity of the reinforced elements. By way of example, selected load-bearing structural members of the building, such as beams, headers, joists, or curved structural members, may be reinforced with external reinforcement sleeves 122 formed from carbon fiber reinforced polymer (CFRP) materials. Carbon fiber reinforcement systems, including laminates, wraps, or sheets bonded to timber elements, can significantly increase the load-carrying capacity, stiffness, and live-load rating of floor and roof members while maintaining a relatively low overall weight compared to equivalent steel or concrete reinforcements. Fiber-reinforced polymer materials are widely used in structural strengthening applications due to their high tensile strength, corrosion resistance, and lightweight characteristics.

In some embodiments, the reinforcement sleeves 122 made of carbon fiber are designed to closely conform to the geometry of weight-bearing structural elements. Use of carbon fiber-based reinforcement sleeves 122 may increase the structural strength of reinforced elements by up to approximately 35 percent, depending on material selection, application method, and loading conditions. Carbon fiber reinforcement enhances the mechanical properties of wood by significantly increasing tensile strength and stiffness. When applied to wood, particularly to curved or high-stress regions, the carbon fiber reinforcement improves rigidity and reduces deflection, thereby increasing overall building stability. Wrapping wood members with carbon fiber reinforcement sleeves 122 increases load-carrying capacity and enables the members to support heavier loads without excessive deformation. In addition, carbon fiber reinforcement improves durability and resistance to environmental degradation, including moisture-related deterioration. Carbon fiber materials are lightweight, flexible, and easily cut or shaped, making them well suited for retrofitting and reinforcing existing structural elements. By way of non-limiting examples, carbon fiber reinforcement may be used to increase live load capacity of floors, support installation of heavy equipment, adapt buildings for new uses, restore aging construction materials, repair fire-damaged wood, modify slabs or framing members where openings have been introduced, or correct design or construction deficiencies. Through incorporation of reinforcement sleeves 122, the system 100 further enhances structural resilience and adaptability while maintaining efficient material usage.

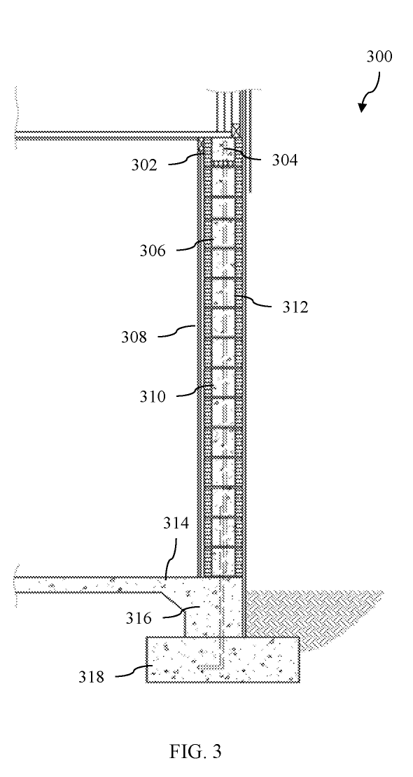

FIG. 3 illustrates an exemplary representation of a garage 300 forming part of the sustainable and weather-resistant building system 100. As shown, the garage 300 is constructed using reinforced masonry and concrete techniques designed to provide enhanced structural strength and durability. In one embodiment, the system 100 incorporates a double-course knock-out block bond beam 302 positioned at an upper portion of the wall assembly. The bond beam 302 includes multiple horizontal reinforcing bars disposed near both upper and lower regions of the beam and is filled with concrete to form a reinforced structural element. A vertical reinforcing bar 304 may be configured to hook over a top horizontal reinforcing bar using a 90-degree bend and a minimum lap splice at the top bar to ensure adequate load transfer and anchorage. By way of example, five vertical rebars 306 may be installed within a concrete-filled CMU cell and extend continuously from the foundation to a tie beam. An interior stucco finish 308 is applied to an interior surface of the block wall of the garage 300, while an 8-inch concrete block 310 is laid in a running bond pattern to form the wall structure. An exterior stucco finish 312 is applied over the exterior surface of the block wall to provide weather protection and durability. The garage 300 further includes a four-inch thick monolithic concrete slab 314 incorporating a fiber additive to improve crack resistance. The slab 314 is installed over a 6-mil plastic vapor barrier, which is lapped by approximately six inches and taped at seams to inhibit moisture migration. The slab 314 is placed over compacted fill to provide a stable base. A 16-inch high by 12-inch wide concrete downpour 316 incorporating multiple reinforcing bars is formed at the slab edge, in conjunction with a concrete footing 318, to provide additional load distribution and anchorage.

In some embodiments, the slab 314 and associated footing 318 are poured as a single, continuous concrete placement, thereby forming a monolithic foundation structure. Vertical reinforcing steel members are embedded within the slab 314 and footing 318 and extend upward into the exterior wall structures 104, where they are mechanically tied into one or more horizontal bond beams, including the double knock-out bond beam 302, formed within courses of CMUs. The vertical reinforcing members may be embedded within block cells that are substantially or fully filled with concrete or grout. By fully grouting the block cells and integrally connecting the vertical reinforcing members to the horizontal bond beams and the monolithic slab 314 and footing 318, the foundation and wall structures 102 and 104 function together as a unitary structural element rather than as discrete or segmented components. This configuration increases moment continuity across the slab-to-wall interface and improves transfer of vertical, lateral, and overturning loads. In contrast to conventional construction practices, where block walls may be only partially grouted and slabs, footings, and walls are poured in separate operations that introduce cold joints, the disclosed building system 100 reduces the likelihood of cracking, separation, or localized failure at such interfaces. In one or more embodiments, each filled block cell may receive a substantial quantity of concrete or grout, for example at least approximately 120 pounds of concrete per filled cell, depending on block size and spacing. This level of concrete fill provides increased mass, stiffness, and durability relative to typical partially grouted masonry walls.

In some embodiments, the slab 314 is formed using controlled concrete placement techniques that promote uniform distribution and consolidation of concrete, thereby reducing voids, segregation, and inconsistencies. Such placement techniques improve homogeneity and long-term performance of the slab 314. The slab 314 may be formed as a fiber-reinforced concrete slab having a thickness of approximately four inches, although other thicknesses may be employed. The fiber reinforcement may include synthetic fibers, steel fibers, glass fibers, or combinations thereof, dispersed throughout the concrete mix. These fibers bridge microcracks, inhibit crack propagation during curing, and improve resistance to shrinkage, impact forces, and service loads. The combination of fiber reinforcement and controlled placement improves the slab’s ability to withstand differential movement, soil erosion, washout, or undermining caused by flooding or prolonged water exposure. Compared to conventional non-reinforced slabs, the disclosed slab 314 exhibits enhanced toughness, crack resistance, and durability under adverse environmental conditions.

As illustrated in FIG. 3, the garage 300 is designed to provide superior strength and durability through the use of 8-inch concrete blocks laid in a running bond pattern. The double-course knock-out block bond beam 302 is reinforced with multiple horizontal rebars at both upper and lower regions and is filled with concrete to provide additional structural stability. Vertical reinforcement includes multiple rebars installed in concrete-filled cells that extend continuously from the foundation to a tie beam, with hooked bars secured using 90-degree bends and minimum lap splices to ensure strong mechanical connections.

The foundation of the garage 300 includes a four-inch thick monolithic concrete slab 314 incorporating a fiber additive for enhanced durability. The slab 314 is installed over a 6-mil plastic vapor barrier that is lapped, taped, and placed on compacted fill to provide effective moisture protection. The garage structure further incorporates 16-inch by 12-inch reinforced concrete downpours 316 and a solid concrete footing 318 to provide a robust base. Interior and exterior wall surfaces may be finished with stucco layers 308 and 312, respectively, to provide clean, durable, and weather-resistant finishes.

In the illustrated embodiment, vertically oriented reinforcing steel bars 306, for example five rebars having a diameter of approximately 5/8 inch, extend from the monolithically poured concrete footing 316 upward through the filled block cores. These rebars 306 are mechanically tied into the double knock-out horizontal bond beam 302 at a course above the wall base. This arrangement ensures structural continuity of reinforcing steel across both vertical and horizontal directions, improving integration of the wall system with the foundation 318 and the bond beam 302.

The monolithic footing 316 and slab 314 may be formed as a single continuous concrete placement in which the vertical rebars 306 are embedded prior to concrete placement. Embedding the rebars 306 in the footing 316 provides adequate development length and mechanical anchorage consistent with reinforced concrete design practices, thereby enhancing load transfer between the foundation and wall systems.

In some embodiments, the use of a four-inch thick fiber-reinforced concrete slab 314 poured over a continuous 6-mil vapor barrier with lapped and taped seams further contributes to the integrated structural assembly of the garage 300. The vapor barrier limits moisture migration from below the slab, while fiber reinforcement reduces cracking and improves post-cracking performance under service loads. Collectively, the concrete-filled CMU cells with vertical rebars 306, the integrated bond beam 302, and the monolithic slab 314 and footing 316 provide a unified foundation-to-wall connection. This continuous load path enhances resistance to lateral forces, uplift, and overturning moments imposed by environmental loads such as high winds, seismic activity, and hydrostatic pressures, thereby improving the overall resilience and durability of the garage 300 within the building system 100.

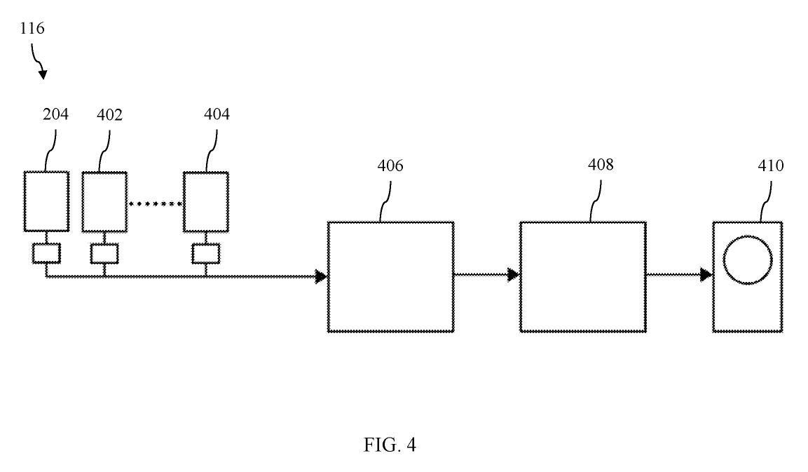

FIG. 4 illustrates an exemplary representation of the energy generating system 116 of the building system 100. As illustrated, the PV panels 204 operate using semiconducting materials configured to convert incident sunlight into electrical energy through the photovoltaic effect. A single photovoltaic device 204, also referred to as a photovoltaic cell or panel, generates direct current (DC) electricity when exposed to solar radiation. Multiple PV devices 204 may be electrically connected in series and/or parallel arrangements to form larger power-generating units commonly referred to as photovoltaic modules or panels. The energy generating system 116 includes a micro-inverter 402, which is a compact power electronics device configured to convert the DC electrical power produced by an individual PV panel 204 into alternating current (AC) electrical power suitable for residential or commercial use. Unlike centralized or string inverters that are electrically coupled to an entire array of PV panels, each micro-inverter 402 may be directly attached to a corresponding PV panel 204, thereby enabling module-level power conversion and optimization. A junction box 404 may be installed on a rear surface of each PV panel 204. The junction box 404 houses electrical conductors, terminals, and protective components, such as bypass diodes, and functions to electrically isolate and protect internal connections from moisture, dust, ultraviolet exposure, and other environmental conditions. In some embodiments, the energy generating system 116 includes micro-inverters 406 configured as grid-forming inverters, which are capable of operating independently of the utility grid and establishing a stable voltage and frequency reference. The use of grid-forming micro-inverters eliminates or reduces conventional limitations on battery sizing and system configuration, enabling enhanced flexibility and scalability of the energy storage system. The energy generating system 116 may further include a peak energy saving and management block 408 configured to reduce utility demand charges by implementing a peak-shaving energy management algorithm. The block 408 stores excess solar-generated electrical energy during low-demand periods and selectively discharges stored energy during periods of peak demand, when utility electricity costs are highest. In one example, the peak energy saving and management block 408 includes a fully integrated battery structure that may be stacked up to six units at a single installation site, collectively providing between approximately 180 kWh and 540 kWh of available backup energy. This configuration enables sustained operation of critical electrical loads during grid outages and demand-response events. The energy generating system 116 may also incorporate a bi-directional utility meter 410 configured to measure electrical energy flow in both directions between the building system 100 and an external utility grid. The meter 410 records energy delivered from the utility (“kWh delivered”) and energy exported to the utility (“kWh received”) based on the difference between on-site generation and on-site electrical demand. Excess energy generated by the solar energy generating system 116 after satisfying on-site loads may be exported to the utility grid. When calculating a billing period, a customer may be billed only for net energy consumption. If the exported energy exceeds consumption, the customer may receive a credit that can be applied to future billing cycles.

The sustainable and weather-resistant building 100 may be equipped with a solar energy generating system 116 designed to provide high efficiency, sustainability, and energy independence. The PV cells 204 capture solar radiation and convert it into electrical energy, while the micro-inverters 402 and 406 operate at the module level to optimize power output from each PV panel 204 independently. This configuration mitigates energy losses caused by shading, panel mismatch, or degradation. The junction box 404 consolidates electrical connections and routes generated power through the micro-inverters to downstream electrical components. The converted AC power may be supplied directly to building electrical loads or stored within an associated battery-based energy storage structure for later use. The bi-directional utility meter 410 tracks both energy production and consumption, thereby enabling seamless integration with the utility grid and facilitating cost savings through net metering or similar programs. Collectively, the solar energy generating system 116 provides a reliable, environmentally responsible power source suitable for modern residential and commercial applications.

In one or more embodiments, the energy storage system 118 includes one or more rechargeable batteries operated in a controlled charge-discharge cycle. The cycle may begin at sunset, when PV generation declines, with stored energy being discharged to support building electrical loads during night-time hours. During daylight hours, when solar energy is available, the batteries are recharged by the PV panels 204. Routine cycling of the batteries maintains the state of charge within an optimal operational range, improves energy management, and increases utilization of self-generated solar energy. Regular charge-discharge operation also helps preserve battery health and ensures that sufficient storage capacity remains available when utility grid outages occur due to storms or other disruptions. Compared to battery systems that are used only during emergencies, routine cycling improves energy autonomy, reduces grid dependence, and enhances resilience during both daily operation and extreme conditions.

An advantage of the energy storage system 118 is that, through appropriate sizing of the PV array and optimization of individual PV modules 204, the building system 100 may generate an amount of electrical energy on an annual basis that is equal to or greater than the total energy consumed by the building. Oversizing the PV array relative to typical demand and employing module-level power electronics such as micro-inverters improves overall energy harvest and system efficiency. Such configurations enable net-zero energy operation, in which annual energy generation equals annual consumption, or net-positive energy operation, in which energy generation exceeds consumption. In addition to meeting annual energy requirements with renewable sources, the energy storage system 118 may supply extended backup power during prolonged grid outages. Module-level micro-inverters improve resilience by reducing losses associated with partial shading, electrical mismatch, or individual module failure, thereby outperforming centralized inverter architectures in many operating conditions.

In some embodiments, the standing seam metal roof 202 of the roof structure 106 includes continuous raised seams or ribs that function as secure attachment points for clamps or mounting brackets associated with the PV modules 204. These attachment mechanisms engage the raised seams without penetrating the roofing membrane. By clamping PV modules 204 directly to the standing seams of the roof 202, the structural and waterproof integrity of the roofing system is preserved. Non-penetrating attachment methods reduce potential pathways for water infiltration, minimize long-term maintenance concerns, and decrease the likelihood of seal degradation. Additionally, such attachment techniques enhance resistance to uplift forces during high-wind events by maintaining continuous roof surface integrity. Standing seam clamp systems are widely used in solar installations to support secure mounting of PV modules 204 while preserving roof durability and performance over extended service life.

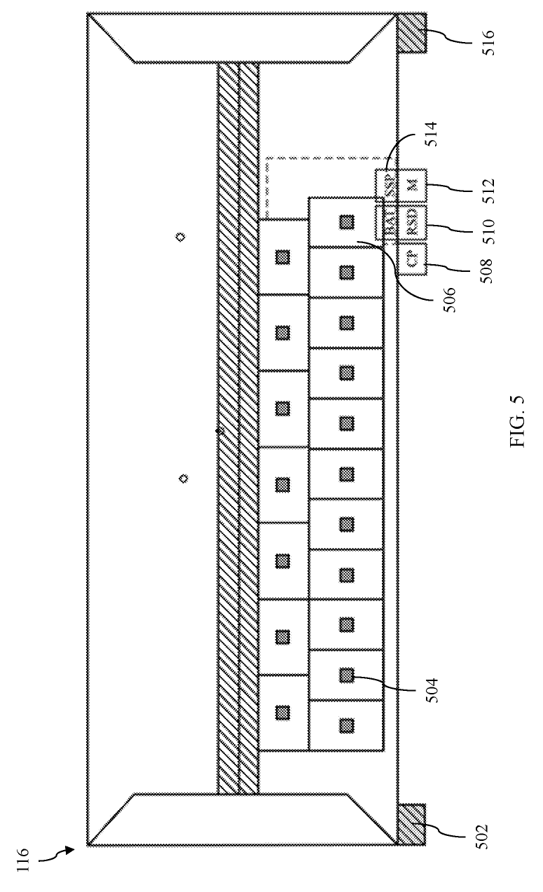

FIG. 5 illustrates another exemplary structural design of the solar energy generating system 116 installed in the weather-resistant building 100. In one or more embodiments, the energy generating system 116 includes a permanent anchor 502 configured for use with a personal fall-protection mechanism. The permanent anchor 502 may be engineered to withstand an ultimate load capacity in all required directions sufficient to arrest a fall, for example a minimum force of approximately 22 kN (5,000 pounds), consistent with occupational safety standards. The permanent anchor 502 may be integrally secured to the roof structure 106 or underlying structural framing to provide a reliable attachment point for safety harnesses, lanyards, or lifelines used during installation, inspection, or maintenance of rooftop equipment. A PV array 504 comprising a plurality of PV panels 204 is mounted to a robust supporting structure associated with the roof structure 106. The PV panels 204 may be mechanically secured using non-penetrating or penetrating mounting hardware, depending on system design and local code requirements, and are electrically interconnected to form the PV array 504. The total number and arrangement of PV panels 204 within the array 504 determines the overall electricity-generating capacity of the energy generating system 116. The system 116 may further include a home battery 506 configured to integrate clean, renewable energy generation with available building automation platforms. The home battery 506 enables enhanced control, comfort, and protection during grid outages by storing surplus solar energy and selectively supplying stored energy to building loads. In one or more embodiments, a scalable energy management mechanism is employed to manage energy usage efficiently, provide smart and configurable backup power during grid disruptions, and supply solar-derived electrical energy to connected smart devices during both daytime and night-time operation. In certain installations, additional system components or expanded storage capacity may be incorporated to achieve a desired level of surplus power generation and extended backup duration. The energy generating system 116 may also include one or more combiner boxes 508 that function as centralized electrical enclosures where wiring from multiple PV panels 204 or PV strings is gathered and organized. The combiner box 508 consolidates electrical outputs and routes the combined power through a single or reduced number of conductors to downstream components such as inverters or charge controllers, depending on the system configuration. A PV cell rapid shutdown device 510 may be installed in electrical communication with a supply authority meter for single-dwelling units. The rapid shutdown device 510 is configured to quickly de-energize PV conductors in response to a shutdown command, thereby improving safety for first responders and maintenance personnel. A bi-directional utility energy meter 512 is positioned outside the building 100 to measure electrical energy flow in both directions. The meter 512 records energy drawn from the utility grid and energy exported to the grid from the PV array 504, thereby enabling accurate billing and crediting under net-metering or similar utility programs. The system 116 may further include one or more electrical sub-panels 514 that act as intermediary distribution panels for directing electrical power to designated circuits or zones within the building. The sub-panels 514 provide circuit protection and allow selective isolation and prioritization of loads, particularly during backup power operation. Additionally, roof anchor points 516 may be installed at selected locations on the roof structure 106 to provide secure tie-off points for fall-protection systems, including single-user anchors or horizontal lifeline systems. The roof anchor points 516 allow workers to attach safety harnesses, ropes, or other protective equipment while performing work on the roof. Collectively, the components illustrated in FIG. 5 demonstrate an integrated approach that combines renewable energy generation, electrical safety, energy resilience, and worker protection within a single, coordinated system architecture.

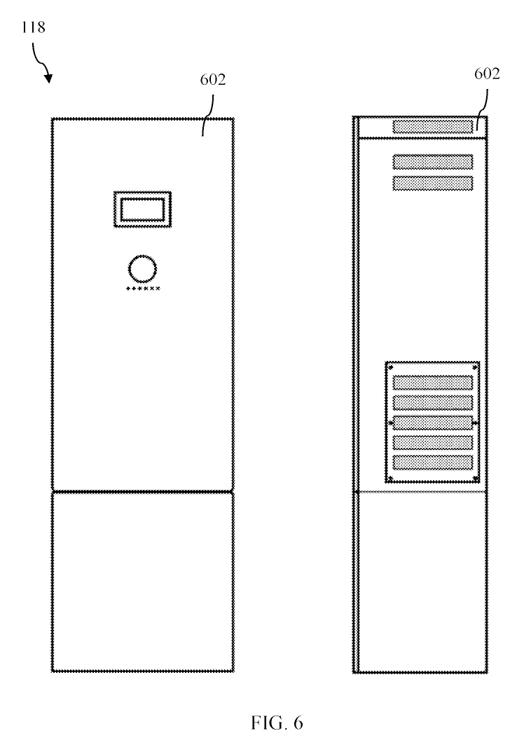

FIG. 6 illustrates an exemplary representation of the energy storage system 118 of the building system 100. The energy storage system 118 may be equipped with one or more battery packs 602 configured for seamless electrical and operational integration with the solar energy generating system 116. In operation, the energy storage system 118 stores surplus electrical energy generated by the PV array 504 during periods of excess solar production and makes the stored energy available during periods of peak electrical demand, night-time operation, or utility power outages. The energy storage system 118 enhances overall building sustainability and operational efficiency by enabling optimized energy consumption, reducing reliance on the external utility grid, and lowering utility expenses. In one or more embodiments, the energy storage system 118 incorporates advanced battery technologies, power electronics, and control algorithms that support rapid response to load changes and seamless transitions between grid-connected and islanded operating modes. The system 118 may be housed in a compact and aesthetically integrated enclosure and is configured to improve energy resilience while maximizing the utilization of renewable energy resources.

Modern building construction often relies on large quantities of concrete, for example on the order of 70 tons, to achieve exceptional structural strength and durability. However, the disclosed resilient and sustainable weather-resistant building 100 is specifically designed to address the unique challenges associated with storm-prone regions, such as coastal environments and areas subject to hurricanes, heavy rainfall, flooding, and climate-driven power disruptions. In such regions, prolonged utility outages are common during severe weather events. The advanced and intelligent energy storage system 118 ensures continuity of electrical power during such outages by supplying stored energy to essential building loads. This capability provides occupants with enhanced security, comfort, and operational continuity when utility service is interrupted. By combining robust structural construction with integrated renewable energy generation and storage, the building system 100 delivers a synergistic blend of physical durability and energy resilience. This integrated approach establishes a new benchmark for sustainable, self-reliant living in extreme environmental conditions, where both structural integrity and reliable access to electrical power are critical.

A primary structural advantage of the building system 100 is the provision of an integrated and continuous mechanical load path extending from the roof structure 106 to the foundation structure 102. In particular, the use of engineered metal strapping, connectors, and fastening components, such as those commercially available as Simpson Strong-Tie strapping mechanisms 206 and 208, or functionally equivalent engineered connector systems, enables structural loads to be transferred in a continuous and controlled manner from the uppermost roof components to the underlying foundation. In one or more embodiments, structural loads originating at the roof structure 106, including loads applied to roof sheathing, standing seam metal roofing panels, rafters, trusses, or other roof framing members, are mechanically transferred through the wall framing system. Specifically, these loads are conveyed through the wall studs 212, double top plates, intermediate framing members, and bottom plates, and into the exterior wall structures 104. The exterior wall structures 104 may be formed from reinforced CMUs having fully grouted cells and embedded vertical reinforcement, or from functionally equivalent load-bearing wall systems. From the exterior wall structures 104, the loads are further transferred into the monolithically poured concrete slab and associated footing or foundation structure 102, which distributes the loads into the supporting soil. This continuous load path is configured to efficiently distribute and resist multiple types of structural forces encountered during extreme environmental events. Such forces include uplift forces generated by high-velocity winds acting on the roof structure 106, racking forces caused by lateral wind pressure acting on the wall structures 104, and horizontal, lateral, and overturning loads induced by severe storms, hurricanes, or seismic activity. The engineered metal strapping and connector components 206, 208 may be installed at regular intervals around the building perimeter and at critical structural interfaces, such as stud-to-plate connections, plate-to-wall connections, wall-to-foundation connections, and roof-to-wall connections, thereby ensuring continuity of load transfer throughout the structure.

By mechanically tying together the roof structure 106, wall structures 104, and foundation structure 102, the disclosed building system 100 reduces or eliminates reliance on isolated or discontinuous connection methods commonly used in conventional stick-built construction. Such conventional methods may include discrete anchor bolts, friction-based bearing connections, toe-nailing, or intermittently spaced fasteners that do not provide a fully engineered load path. These traditional approaches often rely on localized connections that can become points of failure when subjected to extreme uplift, lateral, or cyclic loading. In contrast, the integrated load path described herein provides enhanced structural continuity and redundancy by distributing loads across multiple interconnected components rather than concentrating forces at isolated fastener locations. This configuration significantly improves the ability of the building system 100 to resist progressive failure mechanisms under extreme loading conditions. The benefits of such an integrated load path are particularly pronounced in geographic regions prone to high-intensity wind events, including areas susceptible to Category 4 and Category 5 hurricanes, where sustained wind speeds, gust loads, and uplift forces can exceed the design capacity of conventional residential and light commercial building assemblies. As a result, the integrated load path implemented in the building system 100 improves overall structural performance, long-term durability, and resilience of the building when subjected to extreme weather conditions. The coordinated interaction of the roof, wall, and foundation assemblies enhances the building’s ability to maintain structural integrity, reduce damage, and protect occupants during severe environmental events.

Another significant advantage of the building system 100 is its integrated energy management capability combined with enhanced weather-resistant performance. The building system 100 incorporates a coordinated energy generation system 116, energy storage system 118, and controller 120 that together provide intelligent management of electrical energy under both normal operating conditions and adverse environmental events. In particular, the energy generation system 116, which may include PV array supported by the roof structure 106, is configured to generate renewable electrical energy that is consumed directly by building loads and, when excess energy is available, stored in the energy storage system 118 for later use. The controller 120 actively monitors energy production, energy storage state, utility grid availability, and electrical demand, and dynamically allocates electrical power to optimize efficiency, reduce peak demand, and maintain operational continuity. During utility grid outages caused by extreme weather events, such as hurricanes, severe storms, or flooding, the controller 120 automatically transitions the building system 100 into an islanded operating mode in which electrical power is supplied from the energy storage system 118 and the energy generation system 116. In this mode, the controller 120 prioritizes delivery of electrical power to selected critical loads, such as refrigeration, lighting, communications equipment, medical devices, and climate control systems, via one or more electrical sub-panels. This automated power management capability allows the building system 100 to remain habitable and functional for extended durations during grid outages, significantly improving occupant safety and comfort compared to conventional buildings that lack integrated energy storage and control.

In addition to its energy management functionality, the building system 100 exhibits enhanced resistance to weather-related hazards through the integration of resilient structural, envelope, and energy subsystems. The roof structure 106, wall structures 104, and foundation structure 102 are cooperatively designed to resist uplift, lateral, and hydrostatic loads associated with extreme wind and flood events. The non-penetrating attachment of PV modules to the standing seam metal roof preserves the integrity of the roofing membrane, reducing the likelihood of water intrusion during heavy rain or wind-driven precipitation. The building envelope assemblies 110, including sealed sheathing layers, closed-cell spray foam insulation, and impact-resistant fenestration elements 112, further enhance resistance to wind, rain, and airborne debris. Moreover, the integration of flood pressure relief elements 114 within the wall structures 104 reduces hydrostatic pressure during flooding events, mitigating structural damage that can compromise both the building envelope and the energy systems housed within the structure. By maintaining structural integrity and preventing moisture intrusion, the building system 100 protects critical electrical components, including the energy storage system 118 and associated electrical distribution equipment, from water-related damage. The combined energy management and weather-resistant capabilities of the building system 100 therefore provide a synergistic advantage, enabling continued operation, reduced recovery time, and improved resilience in environments subject to severe and recurring weather events.

### INDUSTRIAL APPLICABILITY

The disclosed system 100 is industrially applicable to design, construction, and operation of residential, commercial, and mixed-use buildings in regions subject to extreme environmental conditions, including high-wind storms, hurricanes, flooding events, and utility grid instability. The system 100 may be implemented using commercially available construction materials, structural connectors, masonry components, insulation systems, PV modules, energy storage devices, and control electronics. The integrated structural load path, flood pressure relief configuration, and coordinated energy generation and storage architecture enable scalable deployment across single-family residences, multi-family housing, and light commercial structures. The disclosed system 100 improves building resilience, reduces lifecycle energy consumption, enables net-zero or net-positive energy performance, and enhances occupant safety and operational continuity. Accordingly, the invention is suitable for widespread adoption within the construction, renewable energy, and resilient infrastructure industries.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

1. A system for constructing a sustainable, resilient building, comprising:
a foundation structure;
a plurality of wall structures extending upward from the foundation structure;
a roof structure supported by the wall structures;
a plurality of structural connectors configured to provide a continuous load path from the roof structure through the plurality of wall structures to the foundation structure;
a plurality of building envelope assemblies supported by the plurality of wall structures and the roof structure;
a plurality of fenestration elements in one or more of the plurality of building envelope assemblies;
a plurality of flood pressure relief elements positioned at one or more elevations in at least one of the plurality of wall structures and configured to relieve hydrostatic pressure during a flooding event;
an energy generation system supported by the roof structure; and
an energy storage system electrically coupled to the energy generation system and configured to provide electrical power to at least a subset of loads within the building during grid outages,
wherein the roof structure and the plurality of structural connectors cooperate with the plurality of wall structures and the foundation structure to resist uplift and lateral loads associated with extreme wind events.

2. The system of claim 1, wherein the foundation structure comprises a monolithic concrete slab and an integral footing poured as a single unit.

3. The system of claim 1, wherein each of the plurality of wall structures comprises one or more concrete block walls having a plurality of fully grouted cells with at least one vertical reinforcement bar extending between the foundation structure and one or more horizontal bond beams.

4. The system of claim 3, wherein each of the plurality of fully grouted cells contains at least approximately 120 pounds of concrete surrounding the at least one vertical reinforcement bar.

5. The system of claim 1, wherein the roof structure comprises a standing seam metal roof supported by the plurality of wall structures.

6. The system of claim 1, wherein each of the plurality of structural connectors comprises a plurality of metal strapping elements distributed around a perimeter of the building and configured to couple the roof structure, the plurality of wall structures, and the foundation structure.

7. The system of claim 1, wherein each of the plurality of building envelope assemblies comprises a plurality of framing members with cavities fully filled with closed‑cell spray foam insulation.

8. The system of claim 7, wherein the closed‑cell spray foam insulation in cavities of the plurality of framing members has a thickness of at least approximately six inches.

9. The system of claim 1, wherein each of the plurality of building envelope assemblies comprises a sheathing layer with taped seams providing a sealed air and water barrier behind an exterior cladding.

10. The system of claim 1, wherein each of the plurality of fenestration elements comprises one or more impact‑resistant windows rated for severe wind events.

11. The system of claim 1, wherein each of the plurality of flood pressure relief elements comprises one or more hydro‑sonic flood vents positioned at a height of approximately 14 inches above grade on at least one of the plurality of wall structures.

12. The system of claim 1, further comprising a controller configured to coordinate electrical power flow among the energy generation system, the energy storage system, and one or more electrical loads during grid outages.

13. The system of claim 12, wherein the controller is configured to cause the energy storage system to discharge stored electrical power to at least a subset of the one or more electrical loads during grid outages and to cause the energy storage system to recharge using electrical power generated by the energy generation system when available.

14. The system of claim 1, wherein the energy generation system comprises a photovoltaic array and a plurality of module‑level power conversion devices configured to optimize output of individual photovoltaic modules of the photovoltaic array.

15. The system of claim 12, wherein the energy storage system comprises a battery pack configured to supply continuous power to at least a subset of critical loads of the one or more electrical loads for an extended duration during grid outages.

16. The system of claim 15, wherein the energy storage system and the energy generation system are configured such that the energy generation system generates at least as much electrical energy annually as is consumed by the building.

17. The system of claim 1, wherein the energy generation system is mechanically attached to the roof structure using a plurality of non‑penetrating roof clamps.

18. The system of claim 1, further comprising a bidirectional utility meter configured to measure electrical energy delivered from and exported to an external electrical utility grid.

19. The system of claim 12, further comprising at least one electrical sub‑panel configured to distribute electrical power from the energy storage system to a subset of the one or more electrical loads during grid outages.

20. The system of claim 1, further comprising a plurality of reinforcement sleeves disposed around at least one load‑bearing structural element to increase tensile strength and load carrying capacity of the element.
